(19) United States
(12) Patent Application Publication
(10) Pub. No.: US 2013/0270317 A1
(43) Pub. Date: Oct. 17, 2013

(54) Support and Protection Device for Mobile Apparatus

(71) Applicant: Ching-Chang Wang, Tainan City (TW)

(72) Inventor: Ching-Chang Wang, Tainan City (TW)

(21) Appl. No.: 13/448,468

(22) Filed: Apr. 17, 2012

(51) Int. Cl. B60R 11/00

(52) U.S. Cl. 224/570

(57) ABSTRACT

A support and protection device includes a mounting frame, a connecting unit connected with the mounting frame, a support unit connected with the connecting unit, and an attachment unit connected with the support unit. Thus, the support and protection device is attached to a car by the sucker of the attachment unit and is placed on a horizontal plane by the stand of the attachment unit so that the mobile apparatus is used in the car and can also be operated outdoors. In addition, the support and protection device has an angle adjustable function by the spherical adjusting portion of the connecting unit so that the angle of the mobile apparatus can be adjusted.

### BACKGROUND OF THE INVENTION

1. Field of the Invention

The present invention relates to a support device and, more particularly, to a support and protection device for a mobile apparatus, such as a cell phone and the like.

2. Description of the Related Art

A conventional protection device for a cell phone, such an i-phone and the like, comprises a back guard board and two side guard plates mounted on two opposite sides of back guard board. The back guard board has an upper end provided with at least one upper locking protrusion snapped onto the top of the cell phone and a lower end provided with at least one lower locking protrusion snapped onto the bottom of the cell phone. Thus, the cell phone is covered by the back guard board and the two side guard plates and is locked by the upper locking protrusion and the lower locking protrusion of the back guard board. However, the conventional protection device only has a protection function and cannot support the cell phone so that a user has to hold the cell phone, thereby causing inconvenience to the user when operating the cell phone in photographing or video recording.

### BRIEF SUMMARY OF THE INVENTION

In accordance with the present invention, there is provided a support and protection device, comprising a mounting frame, a connecting unit connected with the mounting frame, and a support unit connected with the connecting unit. The mounting frame encompasses and receives a mobile apparatus. The mounting frame has a sidewall provided with at least one connecting hole. The connecting unit is located between the mounting frame and the support unit. The connecting unit includes a connecting block abutting the mounting frame, at least one locking piece mounted on a first side of the connecting block and detachably locked onto the connecting hole of the mounting frame, and an adjusting knob mounted on a second side of the connecting block. The support unit includes at least one support post pivotally connected with the adjusting knob of the connecting unit.

The primary objective of the present invention is to provide a support and protection device for protecting and supporting a mobile apparatus

According to the primary advantage of the present invention, the support and protection device is attached to a car by the sucker of the attachment unit and is placed on a horizontal plane by the stand of the attachment unit so that the mobile apparatus is used in the car and can also be operated outdoors, thereby enhancing the versatility of the mobile apparatus.

According to another advantage of the present invention, the support and protection device has an angle adjustable function so that the angle of the mobile apparatus can be adjusted easily and freely, thereby facilitating the user using or watching the mobile apparatus.

According to a further advantage of the present invention, the mobile apparatus is initially combined with the mounting frame, and the mounting frame is then connected with the connecting unit so that the mounting frame can cover and protect the mobile apparatus to prevent the mobile apparatus from directly contacting with the connecting unit and to prevent the mobile apparatus from being rubbed or worn by the connecting unit.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a partially exploded perspective view of a support and protection device in accordance with the preferred embodiment of the present invention.

FIG. 2 is a partially exploded perspective view of the support and protection device as shown in FIG. 1.

FIG. 3 is a side cross-sectional assembly operational view of the support and protection device as shown in FIG. 1.

FIG. 4 is a partially side cross-sectional assembly operational view of the support and protection device as shown in FIG. 1.

FIG. 5 is a side cross-sectional assembly view of a support and protection device in accordance with another preferred embodiment of the present invention.

FIG. 6 is perspective view of a support and protection device in accordance with another preferred embodiment of the present invention.

### DETAILED DESCRIPTION OF THE INVENTION

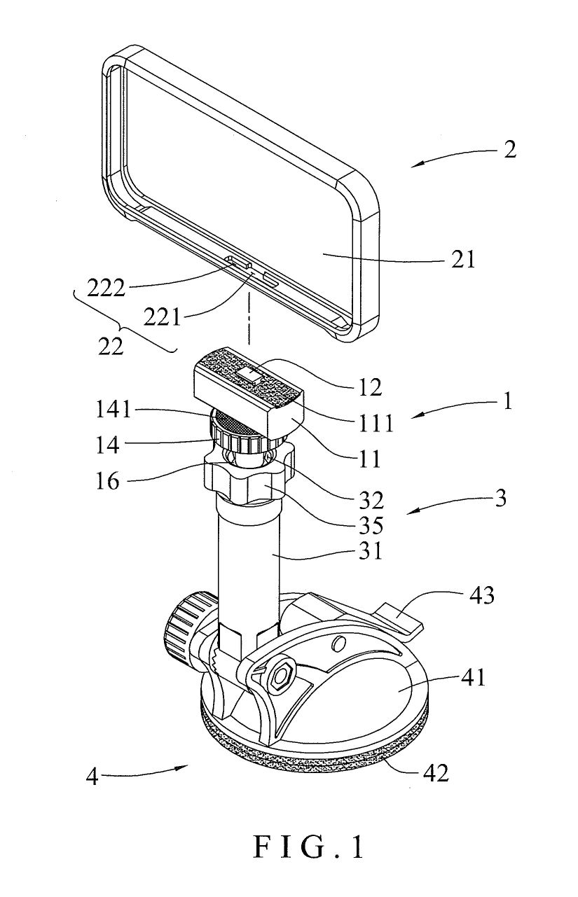

Referring to the drawings and initially to FIGS. 1-4, a support and protection device for a mobile apparatus in accordance with the preferred embodiment of the present invention comprises a mounting frame 2, a connecting unit 1 connected with the mounting frame 2, and a support unit 3 connected with the connecting unit 1.

The mounting frame 2 is used to encompass and receive a mobile apparatus, such as a cell phone, a camera, a photography, a global positioning system (GPS), a car video recorder and the like. Preferably, the cell phone is an i-phone. The mounting frame 2 has a hollow interior provided with a receiving hole 21 to receive the mobile apparatus. The mounting frame 2 has a sidewall provided with at least one connecting hole 22. The connecting hole 22 of the mounting frame 2 is connected to the receiving hole 21. The connecting hole 22 of the mounting frame 2 includes an entrance 221 and a slideway 222. The slideway 222 of the mounting frame 2 is connected to the entrance 221 and has a width smaller than that of the entrance 221. The entrance 221 of the mounting frame 2 is disposed at a middle position of the slideway 222.

The connecting unit 1 is located between the mounting frame 2 and the support unit 3. The connecting unit 1 includes a connecting block 11 abutting the mounting frame 2, at least one locking piece 12 mounted on a first side of the connecting block 11 and detachably locked onto the connecting hole 22 of the mounting frame 2, and an adjusting knob 14 mounted on a second side of the connecting block 11.

The locking piece 12 of the connecting unit 1 has a substantially T-shaped profile. The locking piece 12 of the connecting unit 1 is inserted into the entrance 221 of the mounting frame 2 and is detachably locked onto the slideway 222 of the mounting frame 2. The locking piece 12 of the connecting unit 1 is slidable on the slideway 222 of the mounting frame 2. The first side of the connecting block 11 is provided with an abutting layer 111 abutting the mounting frame 2, and the locking piece 12 of the connecting unit 1 protrudes outward from the abutting layer 111. Preferably, the abutting layer 111 is a soft pad. The second side of the connecting block 11 has a surface provided with a screw bore 13. The adjusting knob 14 of the connecting unit 1 has a first side provided with a threaded rod 15 screwed into the screw bore 13 of the connecting block 11 to connect the adjusting knob 14 with the connecting block 11. The first side of the adjusting knob 14 has a surface provided with an anti-skid layer 141 abutting the connecting block 11 to provide a non-slip function between the adjusting knob 14 and the connecting block 11. The threaded rod 15 protrudes outward from the anti-skid layer 141. The adjusting knob 14 of the connecting unit 1 has a second side provided with a spherical adjusting portion 16.

The support unit 3 includes at least one support post 31 pivotally connected with the adjusting knob 14 of the connecting unit 1, and a fastening nut 35 rotatably mounted on and pressing the support post 31.

The support post 31 of the support unit 3 has a first end provided with a ball recess 32 to receive the spherical adjusting portion 16 of the adjusting knob 14, and the spherical adjusting portion 16 of the adjusting knob 14 is rotatably mounted in the ball recess 32 of the support post 31. The first end of the support post 31 has a peripheral wall provided with a plurality of elongate slits 33 and an external thread 34. The support post 31 of the support unit 3 is made flexible by provision of the elongate slits 33. Each of the elongate slits 33 of the support post 31 is connected to the ball recess 32 and the external thread 34.

The fastening nut 35 of the support unit 3 has an interior provided with an internal thread 36 screwed onto the external thread 34 of the support post 31 to lock the fastening nut 35 onto the support post 31. Thus, when the internal thread 36 of the fastening nut 35 is screwed onto the external thread 34 of the support post 31, the elongate slits 33 of the support post 31 are compressed by the fastening nut 35 so that the support post 31 is contracted inward and pressed toward the spherical adjusting portion 16 of the adjusting knob 14 to lock the spherical adjusting portion 16 of the adjusting knob 14. On the contrary, when the internal thread 36 of the fastening nut 35 is unscrewed from the external thread 34 of the support post 31, the elongate slits 33 of the support post 31 are loosened from the fastening nut 35 so that the support post 31 is expanded outward by its elasticity and spaced from the spherical adjusting portion 16 of the adjusting knob 14 to unlock the spherical adjusting portion 16 of the adjusting knob 14.

The support and protection device further comprises an attachment unit 4 connected with the support unit 3 and bonded onto an object. The attachment unit 4 includes a base 41 pivotally connected with a second end of the support post 31, a sucker 42 mounted on a first side of the base 41, and a pressing handle 43 pivotally mounted on a second side of the base 41 and connected with the sucker 42 to press or loosen the sucker 42.

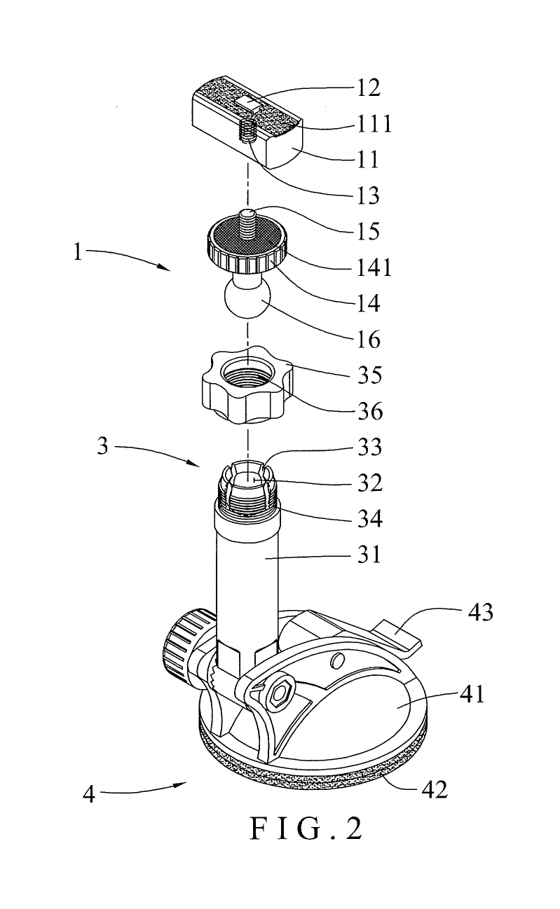

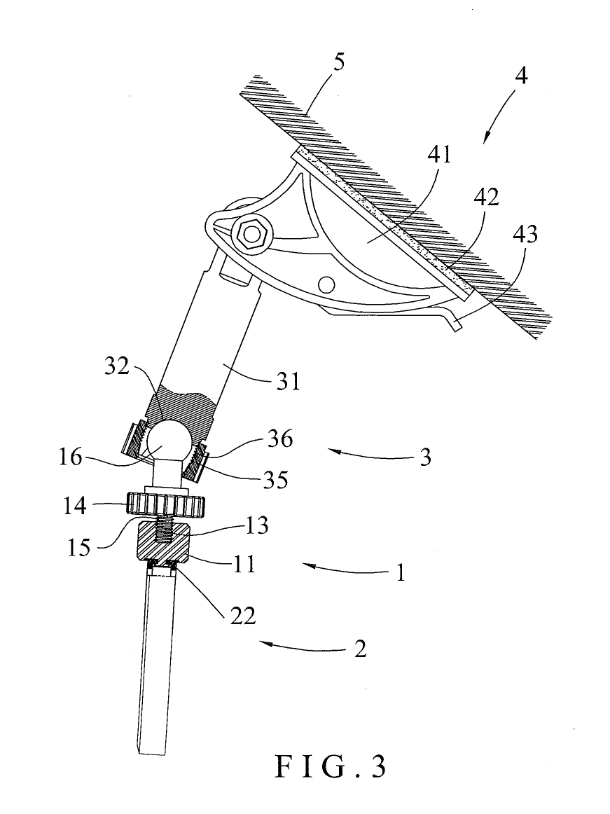

In operation, referring to FIG. 3 with reference to FIGS. 1 and 2, the sucker 42 of the attachment unit 4 is bonded onto an object, such as a windshield 5 of a car so that the support and protection device is attached to the car. In such a manner, the mobile apparatus is received in the mounting frame 2 and is supported by the support unit 3 so that the user needs not to hold the mobile apparatus, thereby facilitating the user operating the mobile apparatus. Thus, the mobile apparatus received in the mounting frame 2 can be placed on the car to perform its function, such as navigation, watching, photographing, video tape recording and the like, thereby enhancing the versatility of the mobile apparatus.

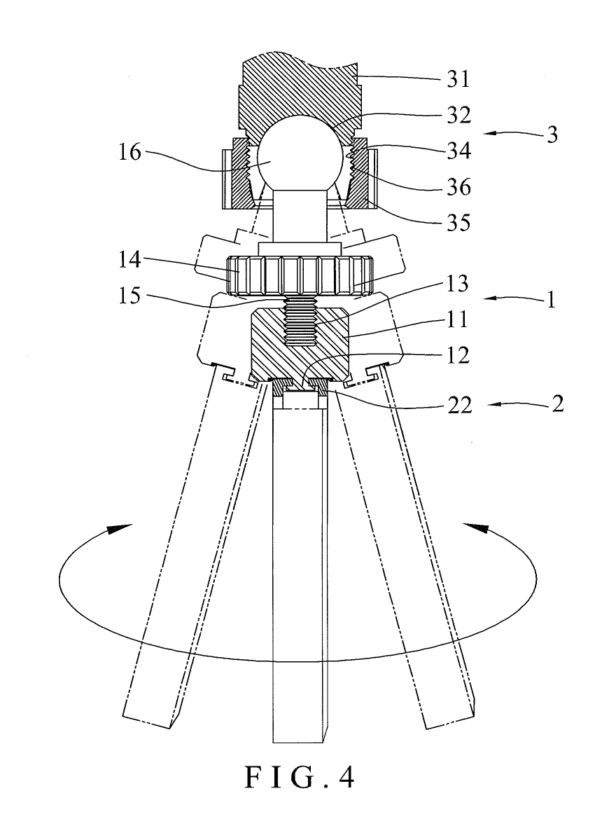

In adjustment, referring to FIG. 4 with reference to FIGS. 1-3, when the internal thread 36 of the fastening nut 35 is unscrewed from the external thread 34 of the support post 31, the elongate slits 33 of the support post 31 are loosened from the fastening nut 35 so that the support post 31 is expanded outward by its elasticity and spaced from the spherical adjusting portion 16 of the adjusting knob 14 to unlock the spherical adjusting portion 16 of the adjusting knob 14. In such a manner, the spherical adjusting portion 16 of the adjusting knob 14 can be rotated in the ball recess 32 of the support post 31 to adjust the angle of the mounting frame 2 so as to adjust the angle of the mobile apparatus, thereby facilitating the user using or watching the mobile apparatus.

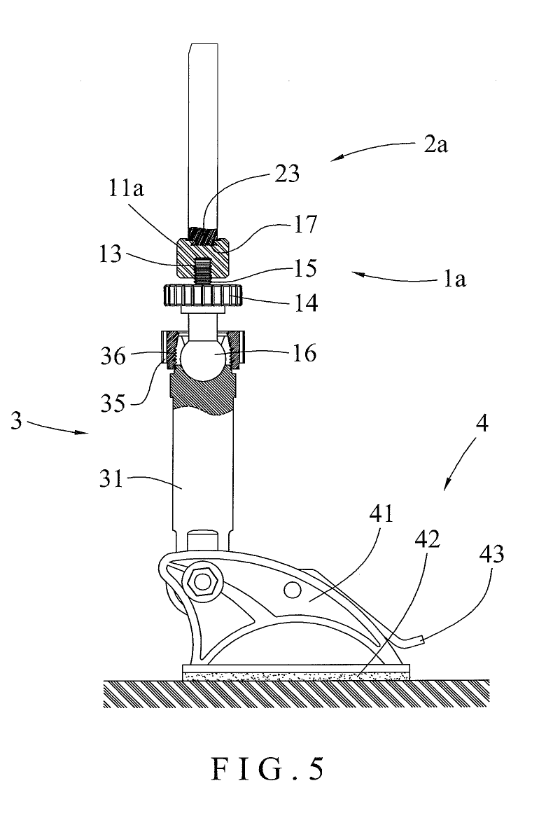

Referring to FIG. 5, the first side of the connecting block 11a of the connecting unit 1a has a surface provided with a slot 17. The mounting frame 2a has a sidewall provided with a plug 23 inserted into the slot 17 of the connecting block 11a to lock the mounting frame 2a onto the connecting block 11a of the connecting unit 1a. The plug 23 of the mounting frame 2a has a dovetailed shape, and the slot 17 of the connecting block 11a has a dovetailed shape.

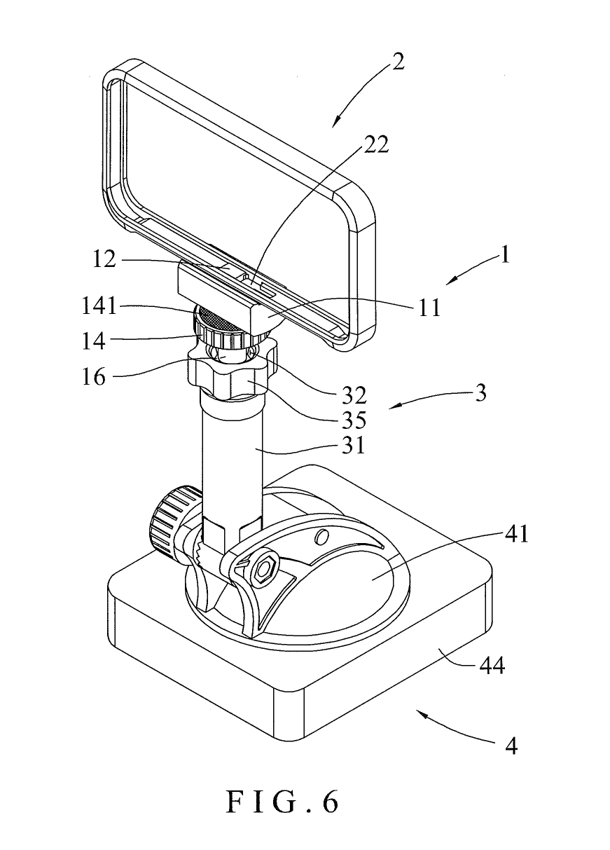

Referring to FIG. 6, the attachment unit 4 further includes a stand 44 connected with the base 41 to support the base 41 on a plane. The stand 44 of the attachment unit 4 is a weight made of metal, such as an iron block and the like. Thus, the mobile apparatus received in the mounting frame 2 is supported by the stand 44 of the attachment unit 4 solidly and stably so that the mobile apparatus is used for outdoor photographing or video tape recording, thereby enhancing the versatility of the mobile apparatus.

Accordingly, the support and protection device is attached to a car by the sucker 42 of the attachment unit 4 and is placed on a horizontal plane by the stand 44 of the attachment unit 4 so that the mobile apparatus is used in the car and can also be operated outdoors, thereby enhancing the versatility of the mobile apparatus. In addition, the support and protection device has an angle adjustable function so that the angle of the mobile apparatus can be adjusted easily and freely, thereby facilitating the user using or watching the mobile apparatus. Further, the mobile apparatus is initially combined with the mounting frame 2, and the mounting frame 2 is then connected with the connecting unit 1 so that the mounting frame 2 can cover and protect the mobile apparatus to prevent the mobile apparatus from directly contacting with the connecting unit 1 and to prevent the mobile apparatus from being rubbed or worn by the connecting unit 1.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A support and protection device, comprising:
a mounting frame;
a connecting unit connected with the mounting frame; and
a support unit connected with the connecting unit;
wherein the mounting frame encompasses and receives a mobile apparatus;
the mounting frame has a sidewall provided with at least one connecting hole;
the connecting unit is located between the mounting frame and the support unit;
the connecting unit includes:
a connecting block abutting the mounting frame;
at least one locking piece mounted on a first side of the connecting block and detachably locked onto the connecting hole of the mounting frame; and
an adjusting knob mounted on a second side of the connecting block;
the support unit includes at least one support post pivotally connected with the adjusting knob of the connecting unit.

2. The support and protection device of claim 1, wherein the locking piece of the connecting unit has a substantially T-shaped profile.

3. The support and protection device of claim 1, wherein
the connecting hole of the mounting frame includes an entrance and a slideway;
the slideway of the mounting frame is connected to the entrance and has a width smaller than that of the entrance;
the entrance of the mounting frame is disposed at a middle position of the slideway;
the locking piece of the connecting unit is inserted into the entrance of the mounting frame and is detachably locked onto the slideway of the mounting frame;
the locking piece of the connecting unit is slidable on the slideway of the mounting frame.

4. The support and protection device of claim 1, wherein
the second side of the connecting block has a surface provided with a screw bore;
the adjusting knob of the connecting unit has a first side provided with a threaded rod screwed into the screw bore of the connecting block to connect the adjusting knob with the connecting block.

5. The support and protection device of claim 4, wherein
the support post of the support unit has a first end provided with a ball recess;
the adjusting knob of the connecting unit has a second side provided with a spherical adjusting portion rotatably mounted in the ball recess of the support post.

6. The support and protection device of claim 5, wherein
the first end of the support post has a peripheral wall provided with a plurality of elongate slits and an external thread;
the support post of the support unit is made flexible by provision of the elongate slits;
each of the elongate slits of the support post is connected to the ball recess and the external thread;
the support unit further includes a fastening nut rotatably mounted on and pressing the support post;
the fastening nut of the support unit has an interior provided with an internal thread screwed onto the external thread of the support post to lock the fastening nut onto the support post;
when the internal thread of the fastening nut is screwed onto the external thread of the support post, the elongate slits of the support post are compressed by the fastening nut so that the support post is contracted inward and pressed toward the spherical adjusting portion of the adjusting knob to lock the spherical adjusting portion of the adjusting knob;
when the internal thread of the fastening nut is unscrewed from the external thread of the support post, the elongate slits of the support post are loosened from the fastening nut so that the support post is expanded outward by its elasticity and spaced from the spherical adjusting portion of the adjusting knob to unlock the spherical adjusting portion of the adjusting knob.

7. The support and protection device of claim 5, wherein
the support and protection device further comprises an attachment unit connected with the support unit and bonded onto an object;
the attachment unit includes:
a base pivotally connected with a second end of the support post;
a sucker mounted on a first side of the base; and
a pressing handle pivotally mounted on a second side of the base and connected with the sucker to press or loosen the sucker.

8. The support and protection device of claim 7, wherein the attachment unit further includes a stand connected with the base to support the base.

9. A support and protection device, comprising:
a mounting frame;
a connecting unit connected with the mounting frame; and
a support unit connected with the connecting unit;
wherein the mounting frame encompasses and receives a mobile apparatus;
the connecting unit is located between the mounting frame and the support unit;
the connecting unit includes:
a connecting block having a first side abutting the mounting frame; and
an adjusting knob mounted on a second side of the connecting block;
the first side of the connecting block of the connecting unit has a surface provided with a slot;
the mounting frame has a sidewall provided with a plug inserted into the slot of the connecting block to lock the mounting frame onto the connecting block of the connecting unit,
the support unit includes at least one support post pivotally connected with the adjusting knob of the connecting unit.

10. The support and protection device of claim 9, wherein
the plug of the mounting frame has a dovetailed shape; and
the slot of the connecting block has a dovetailed shape.
